(19) United States
(12) Patent Application Publication
(10) Pub. No.: US 2011/0117783 A1
(43) Pub. Date: May 19, 2011

(54) PLUG WITH REPLACEABLE FUSE

(76) Inventor: TUN-LI SU, Luzhu Township (TW)

(21) Appl. No.: 12/792,716

(22) Filed: Jun. 2, 2010

(30) Foreign Application Priority Data
Nov. 18, 2009 (TW) 098139065

(51) Int. Cl. H01R 13/68

(52) U.S. Cl. 439/620.26

(57) ABSTRACT

A plug with replaceable fuse includes a base having an extended first terminal and second terminal, the first terminal is connected to a fuse, and a socket of the base has a first solder contact, and the second terminal extending as a second solder contact. The first solder contact and the second solder contact are contained in the solid block safely, and air entrance is reduced to avoid the first solder contact and the second solder contact and the wire soldered onto them from being oxidized.

### BACKGROUND OF THE INVENTION

1. Field of the Invention

The present invention relates to a plug with replaceable fuse, and more particularly to a plug with solder contacts.

2. Description of the Related Art

Typical electric devices in daily usage or in industrial environments usually use alternating current provided through a power cable plug engaged with a wall socket. The power cable plug comprises at least two terminals and optionally a grounding terminal. For safety purposes, some plugs have built-in fuses, and when subjected to an excessive current, the fuse burns out to cause an open circuit. This type of fuse is typically conveniently designed as a tube and is called herein a “fuse body”.

A prior art plug having a fuse body comprises a base with a first terminal and a second terminal. The inside of the base is usually hollow, and a socket is disposed in the hollow section, which can accept a fuse body for electrical connection to the first terminal. In addition, the socket has a first solder contact, and the second terminal also has a second solder contact. The first solder contact and the second solder contact are accepted in the hollow section, which is unstable and insecure. Moreover, since the hollow section is not air tight, the first solder contact and the second solder contact, and the wire soldered onto them, might become oxidized and damaged, which may lead to accidents.

Therefore, it is desirable to provide a plug with replaceable fuse to mitigate and/or obviate the aforementioned problems.

### SUMMARY OF THE INVENTION

An objective of the present invention is to provide a plug with replaceable fuse.

In order to achieve the above-mentioned objective, a plug with replaceable fuse comprises: a base having an extended first terminal and second terminal, a portion of the base forming a solid block, and the base further having an opened hollow section and a moveable cover correspondingly disposed over the hollow section, the hollow section having a socket, the socket capable of accepting a fuse body to electrically connect to the first terminal, the socket having a first solder contact, and the second terminal extending as a second solder contact; wherein the first solder contact and the second solder contact are contained within the solid block.

The first solder contact and the second solder contact are safely contained in the solid block, and the entrance of air is thereby reduced to prevent oxidation of the first solder contact and the second solder contact as well as the wire soldered onto them.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is a perspective exploded view of an embodiment of the present invention.

FIG. 3 is a top view of a box body according to an embodiment of the present invention.

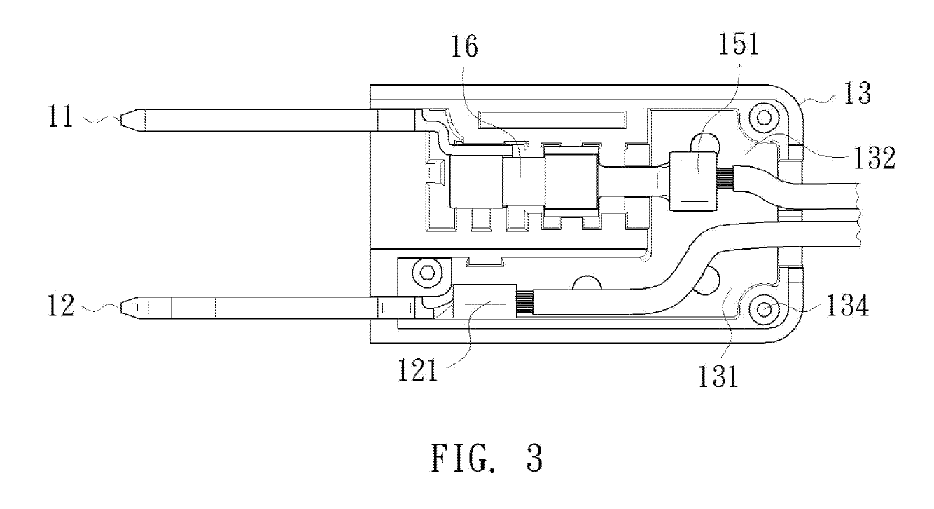

FIG. 4 is a length-wise cross-sectional view of an embodiment of the present invention.

FIG. 5 is a perspective cross-sectional view of an embodiment of the present invention.

FIG. 6 is a perspective schematic drawing of a completed plug according to an embodiment of the present invention.

FIG. 7 is a perspective view of another embodiment of a moveable cover according to the present invention.

FIG. 8 is a perspective schematic view of contact between a socket and a fuse body according to an embodiment of the present invention.

### DETAILED DESCRIPTION OF THE PREFERRED EMBODIMENT

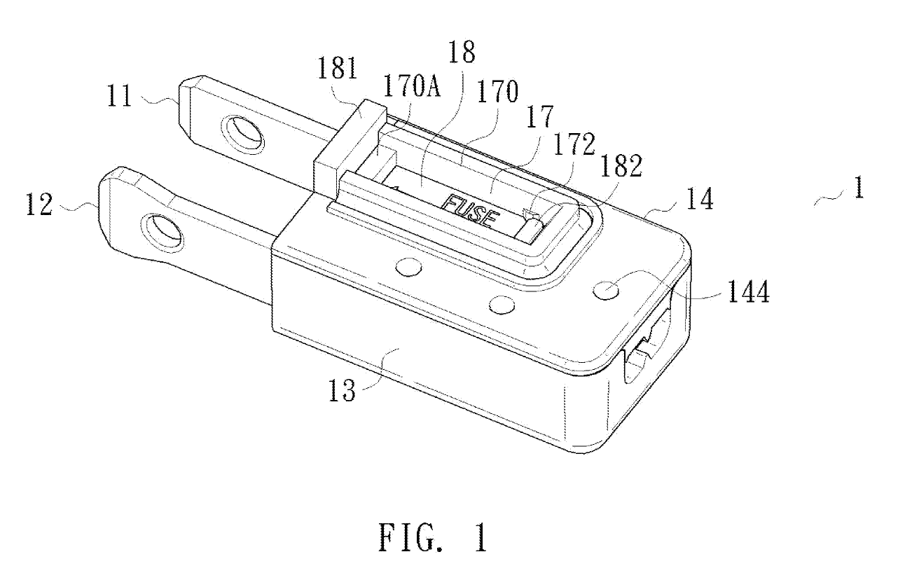

Please refer to FIG. 1. A plug with replaceable fuse comprises a base 1, and the base 1 has an extended first terminal 11 and second terminal 12 to provide an electrically conductive connection.

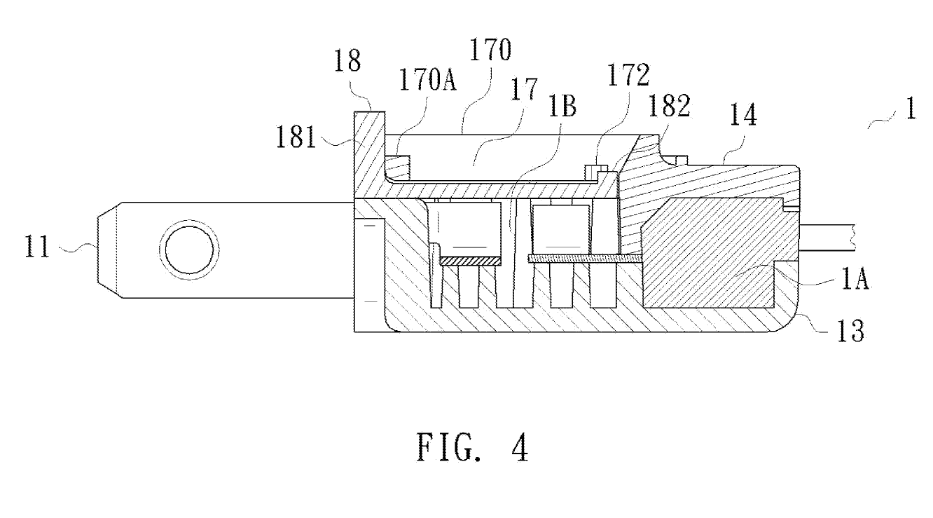

Please refer to FIG. 4. A portion of the base 1 forms a solid block 1A, and the base 1 further has a hollow section 1B with an opening 17, with a trim 170 formed around the opening 17. As shown in FIG. 1, a moveable cover 18 is correspondingly disposed over the hollow section 1B to cover the opening 17. The moveable cover 18 further includes an upward extending grip 181 and an upward extending stopping block 182 at one end.

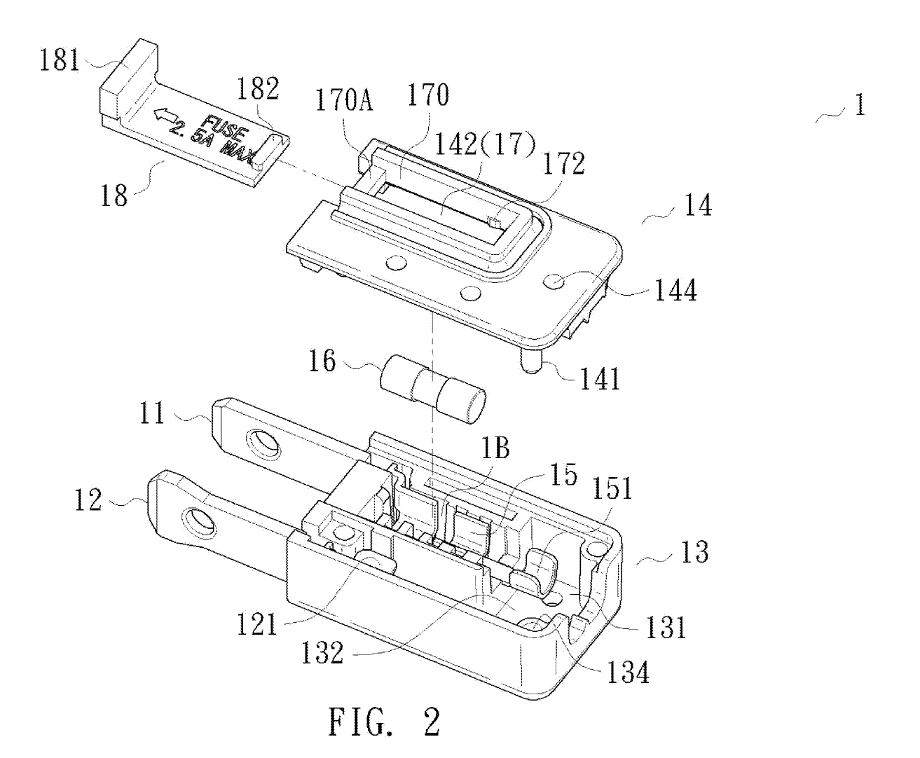

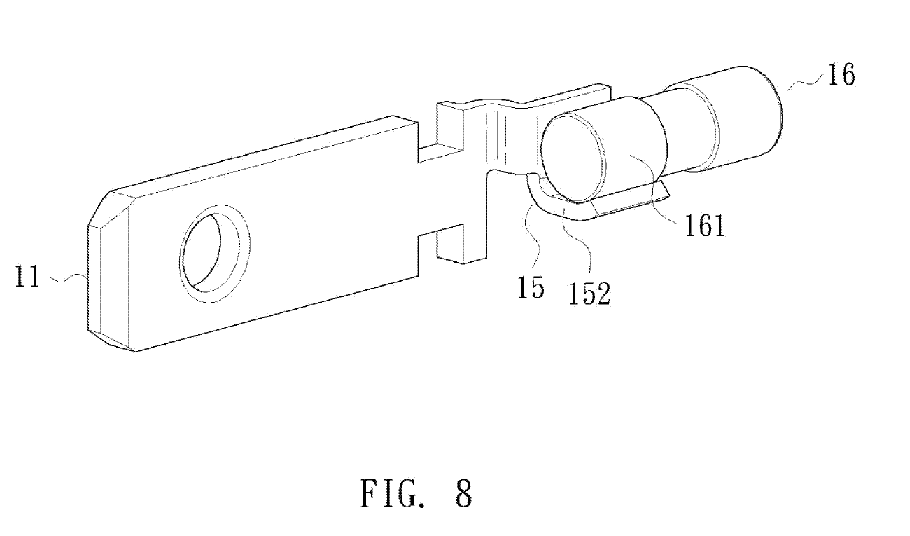

As shown in FIG. 2, the hollow section 1B has a socket 15 inside, and the socket 15 is capable of accepting a fuse body 16 to connect to the first terminal 11. Please refer to FIG. 8. The socket further includes an arced sheet 152 that provides tight contact and a larger contact area with a conductive region 161 of the round columnar fuse body 16. Moreover, the socket further includes a first solder contact 151, and the second terminal 12 extends as a second solder contact 121. The first solder contact 151 and the second solder contact 121 are contained in the solid block 1A.

In an embodiment of the present invention, the base 1 comprises a box body 13 and a top body 14. The box body 13 has an opened chamber 131 and a plurality of securing holes 134 disposed at a bottom side 132 facing the opening of the box body 13.

The top body 14 has a plurality of pins 141 protruding toward the chamber 131, and each pin 141 corresponds to a securing hole 134 to provide engagement between the box body 13 and the top body 14.

The top body 14 further has an opening 142 corresponding to the hollow section 1B as the opening 17, and the solid block 1A is formed by a hardened plastic material that fills a space that is below the base 1 and between the chamber 131. The top body 14 further has a plurality of through apertures 144 connected to the chamber 131, and each through aperture 144 is filled and sealed with a hardened plastic material.

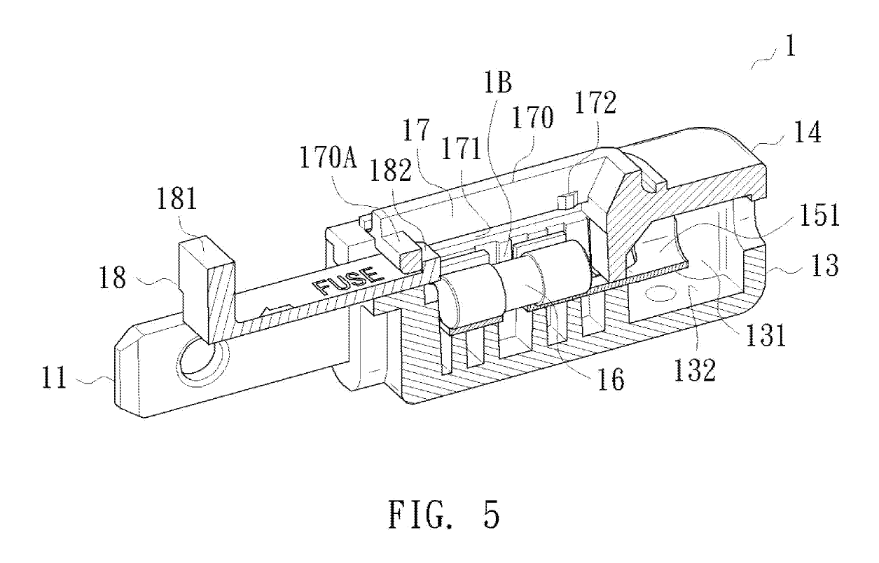

Please refer to FIG. 5. the hollow section 1B has two tracks 171 adjacent to its opening 17, and two sides of the moveable cover 18 are engaged with the tracks 17 such that the moveable cover 18 is moveable along the tracks 17. When the moveable cover 18 is pulled out to its end, the stopping block 182 is stopped at a front edge 170A of the trim 170 of the opening 17 such that the fuse body 16 can be removed and replaced. In addition, in the embodiment shown in FIG. 5, a stop 172 is respectively disposed above both sides of the track 171, which provides a slight resistance for the stopping block 182 but with some extra strength a user can still pull out the stopping block 182.

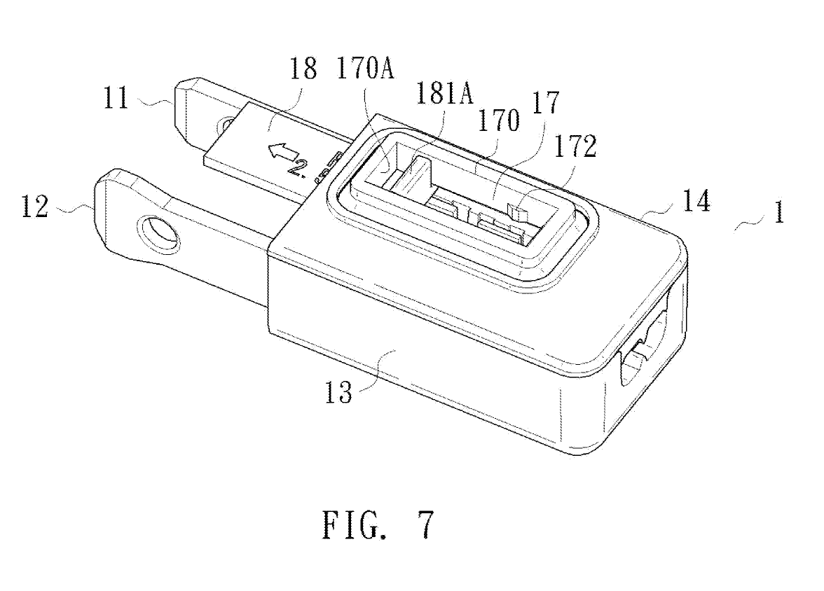

Please refer to FIG. 7. The moveable cover 18 further has a grip 181A, and the grip 181A is disposed adjacent to one end of the moveable cover 18 and in the opening 142 of the top body 14. By pulling on the grip 181A of the moveable cover 18, the moveable cover 18 moves along the tracks 171, (as shown in FIG. 5). When the moveable cover 18 is pulled out to its end, the stopping block 182 is stopped at a front edge 170A of the trim 170 of the opening 17 such that the fuse body 16 can be removed and replaced. In addition, in the embodiment shown in FIG. 7, a stop 172 is respectively disposed above both sides of the track 171, which provides a slight resistance for the stopping block 182 but with some extra strength a user can still pull out the stopping block 182.

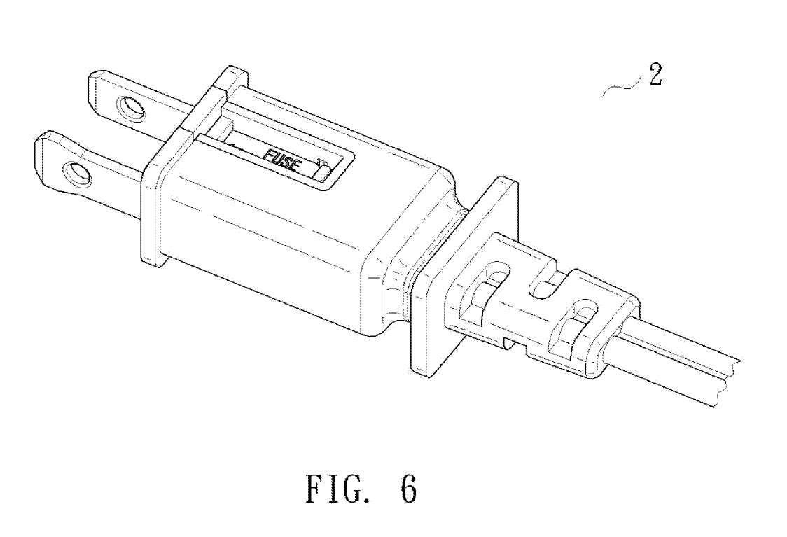

FIG. 6. shows a completed plug of the present invention.

Although the present invention has been explained in relation to its preferred embodiment, it is to be understood that many other possible modifications and variations can be made without departing from the spirit and scope of the invention as hereinafter claimed.

What is claimed is:

1. A plug with replaceable fuse comprising: a base having an extended first terminal and second terminal, a portion of the base forming a solid block, and the base further having an opened hollow section and a moveable cover correspondingly disposed over the hollow section, the hollow section having a socket, the socket capable of accepting a fuse body to connect to the first terminal, the socket having a first solder contact, and the second terminal extending as a second solder contact; wherein the first solder contact and the second solder contact are contained in the solid block.

2. The plug with replaceable fuse as claimed in claim 1, wherein the base comprises:
a box body having an opened chamber and a plurality of securing holes disposed at a bottom side facing the opening of the box body; and
a top body having a the plurality of pins protruding toward the chamber, each pin corresponding to a securing hole; the top body further having an opening corresponding to the hollow section; and the solid block being formed by hardened plastic material filling a space that is below the base and between the chamber.

3. The plug with replaceable fuse as claimed in claim 2, wherein the top body has a plurality of through apertures connected to the chamber, and each through aperture is filled and sealed with hardened plastic material.

4. The plug with replaceable fuse as claimed in claim 1, wherein the hollow section has two tracks adjacent to its opening, and two sides of the moveable cover are engaged with the tracks such that the moveable cover is moveable along the tracks.

5. The plug with replaceable fuse as claimed in claim 1, wherein the moveable cover further has an upward extending grip and an upward extending stopping block at one end, and the opening of the top body further has a trim for stopping the stopping block.

6. The plug with replaceable fuse as claimed in claim 4, wherein a stop is respectively disposed above both sides of the track, and the moveable cover further has an upward extending grip and an upward extending stopping block at one end.

7. The plug with replaceable fuse as claimed in claim 1, wherein the moveable cover further has a grip, and the grip is disposed adjacent to one end of the moveable cover and in the opening of the top body.

8. The plug with replaceable fuse as claimed in claim 1, wherein the socket further has an arced sheet providing tight contact and a larger contact area with a conductive region of the fuse body.
